(19) United States
(12) Patent Application Publication
(10) Pub. No.: US 2011/0087753 A1
(43) Pub. Date: Apr. 14, 2011

(54) SYSTEM FOR DELIVERY OF TARGETED ADVERTISING TO INTERNET USERS

(76) Inventor: Hongtao Yu, Rolling Hills, CA (US)

(21) Appl. No.: 12/876,986

(22) Filed: Sep. 7, 2010

Related U.S. Application Data
(60) Provisional application No. 61/250,612, filed on Oct. 12, 2009.

(51) Int. Cl. G06F 15/16

(52) U.S. Cl. 709/217

(57) ABSTRACT

A method of delivering secondary content for display concurrently with primary content by a web browser running on a user's computer includes running a client-side software application on the user's computer. The client-side software application collects usage data and generates a user profile based on usage data. Multiple items of secondary content are received at the user's computer and characteristics of the items of secondary content are compared with the user profile. At least one of the items is selected based on the comparison and the selected item of secondary content is displayed in a browser window concurrently with the primary content.

### CROSS-REFERENCE TO RELATED APPLICATION

This application claims benefit of U.S. provisional application No. 61/250,612 filed Oct. 12, 2009, the entire disclosure of which is hereby incorporated herein by reference for all purposes.

### BACKGROUND OF THE INVENTION

The subject matter disclosed herein relates to a system for delivering targeted advertising to internet users.

An internet user who employs a web browser application running on a computer to view web pages at web sites will generally access a web page for viewing in a window of the web browser either by entering a web page address on the address line of the browser or by clicking on a hypertext link embedded in a web page that is currently being viewed. In either event, the user's web browser retrieves a web page from a website and displays the page for viewing. Typically, the web page that is displayed to the user will contain both requested, or primary, content, i.e. the content that the user expected to retrieve when he or she entered the web page address or clicked on the hypertext link, and non-requested, or secondary, content. The primary content may be, for example, news, stories, or product reviews and the secondary content may be advertising content. Advertising content may be delivered by use of hypertext links that are embedded in the web page that is retrieved and are activated when the web page is loaded for display. The hypertext links point to advertisements stored on an ad server, and these advertisements are delivered to the user's computer and displayed in the browser window among the primary content of the web page.

There are currently two principal models for delivering an advertisement to internet users who employ web browsers to view content at websites. In accordance with the first approach, the advertisement that is placed in a webpage is selected in a non-targeted fashion, that is, without regard to the user's preferences or browsing history. In accordance with the other approach, the advertisement is selected in a targeted fashion based on keywords entered by a user in a search control or based on the user's browsing history. Use of cookies, spyware, and adware to record and report information regarding a user's browsing history is inefficient, since it requires the software to draw inferences regarding the user's preferences from incomplete and possibly misleading data. The data may be incomplete because the user might have preferences or interests that are not revealed by the browsing history, and the data may be misleading in the event that the particular computer is shared by multiple users. In addition, a computer user may feel that collection of browsing history data violates the user's privacy.

### SUMMARY OF THE INVENTION

According to a first aspect of the disclosed subject matter there is provided a method of delivering secondary content for display concurrently with primary content by a web browser running on a user's computer, comprising running a client-side software application on the user's computer, wherein the client-side software application collects usage data and generates a user profile based on usage data, receiving multiple items of secondary content at the user's computer, comparing characteristics of the items of secondary content with the user profile, selecting at least one of said items based on the comparison, and displaying the selected item of secondary content in a browser window concurrently with the primary content.

According to a second aspect of the disclosed subject matter there is provided a method of delivering secondary content for display concurrently with primary content by a web browser running on a user's computer, comprising running a client-side software application on the user's computer, wherein the client-side software application collects usage data and generates a user profile based on usage data, and, in response to an operating event of the user's computer by transmitting a request for secondary content and at least part of the user profile, receiving at least one item of secondary content at the user's computer after transmission of the request, and displaying a selected item of secondary content in a browser window concurrently with the primary content, wherein the selected item of secondary content has a characteristic that matches a part of the user profile.

### BRIEF DESCRIPTION OF THE DRAWINGS

For a better understanding of the invention, and to show how the same may be carried into effect, reference will now be made, by way of example, to the accompanying drawings, in which:

FIG. 1 is a schematic illustration of a targeted advertising system illustrating partition of functions between a client-side application and a server-side application, and

FIG. 2 is a data flow chart illustrating operation of the targeted advertising system shown in FIG. 1.

### DETAILED DESCRIPTION

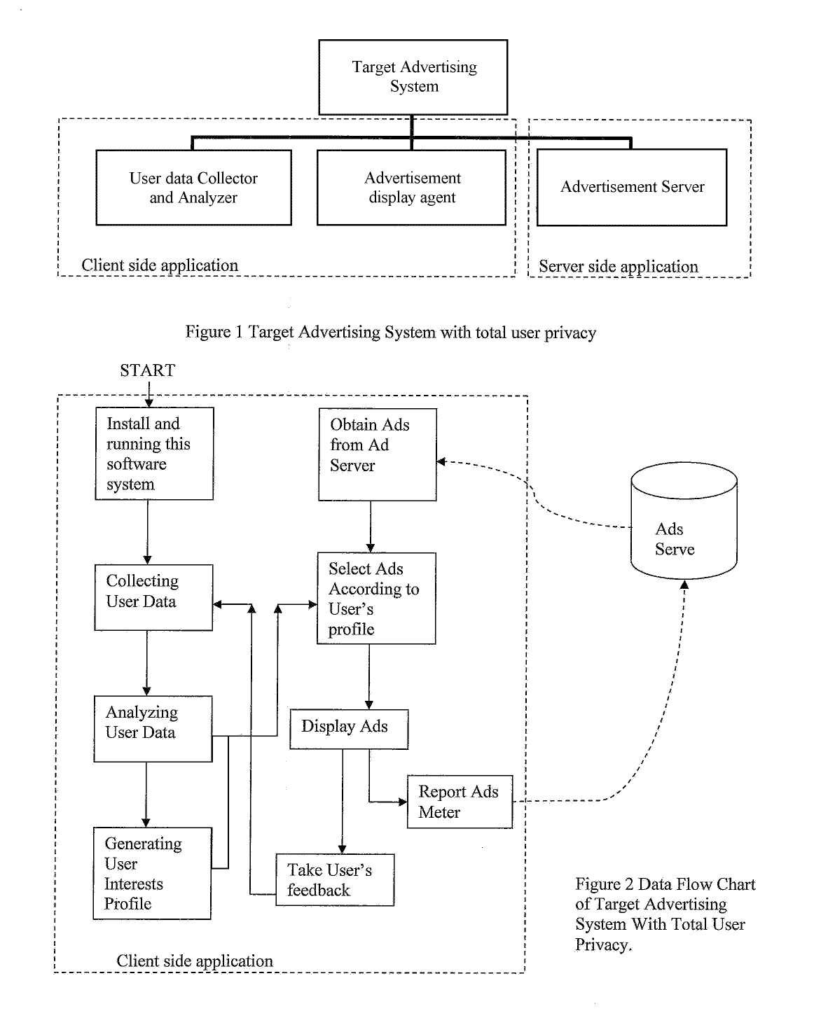

Referring to FIG. 1 of the drawings, a targeted advertising system embodying the subject matter disclosed in this application is composed of a client-side software application and a server-side software application. The client-side software application resides on the user's computer and has two principal functional components. Thus, a user data collector and analyzer collects user data, for example by logging websites visited and advertisement clicking events. The user data collector may also collect and analyze information regarding content that the user accesses offline, much as music selections or reference materials stored on the local hard drive. The user data collector and analyzer analyzes the user data and generates a user interest profile. The user interest profile may have multiple components, such as age, gender, residence location, profession, and hobbies, each component having one of two or more potential predetermined values (or a null value in the event that no value is specified for that component). The user data collector and analyzer may request that the user complete a questionnaire and may employ the user data to refine or augment the profile that is generated on the basis of the questionnaire. In this manner, the user's interests are quantified.

The other principal component of the client-side software application is an advertisement display agent, which communicates with both the server-side software application and the user data collector and analyzer. The server-side application resides on an ad server, which stores advertisements and delivers them to website visitors.

When the user clicks on a hypertext link and the user's computer accesses the selected webpage, containing links to advertisements stored on the ad server, the advertisement display agent receives the ad material from the ad server. The ad server does not select advertisements based on user data collected by software that is concealed from the user, but may supply numerous advertisements for each link in the webpage. Each advertisement includes metadata specifying features of a user profile to which the advertisement is targeted. For example, a given link may point to both an advertisement for a digital camera and an advertisement for knitting yarn, and the respective metadata of the advertisements will specify characteristics of the user profiles to which the respective products might be attractive.

The ad server supplies the advertisements addressed by the activated link to the advertisement display agent, which compares the metadata of the advertisements with the user profile and selects one of the ads for placement in the webpage. When the ad is displayed, the display agent reports back to the ad server that the ad has been displayed, and the ad server uses this information for accounting and billing purposes. In the event that the user clicks on the ad, the user data collector and analyzer may validate the selection made by the advertisement display agent, for example by weighting one or more of the components of the user interest profile that matched the metadata of the selected advertisement.

The advertisement display agent also allows the user to indicate advertisements that are disfavored. The advertisement display agent reports to the user data collector and analyzer, and the user profile may be adjusted to take account of the report.

It will be appreciated from the foregoing that the targeted advertising system described above allows the ad server to supply and display advertisements that are, or might be, of interest to the user without giving the ad server the opportunity to collect such extensive information regarding the user as the targeted advertising methods that are currently in use, and ensures that the ad server is able to display ads relating to products and services in which the user has indicated an interest.

In another implementation of the disclosed subject matter, the client-side software application sends user interest profile data to the server-side application and the ad server uses the user profile data to select ads to be provided for placement in the web page. In this case, therefore, selection of the ads takes place in the sever-side application, but the user profile data is controlled at least partially by the user and the client-side application, which generates the user interest profile, is not concealed from the user.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A method of delivering secondary content for display concurrently with primary content by a web browser running on a user's computer, comprising:
a) running a client-side software application on the user's computer, wherein the client-side software application collects usage data and generates a user profile based on usage data,
b) receiving multiple items of secondary content at the user's computer,
c) comparing characteristics of the items of secondary content with the user profile,
d) selecting at least one of said items based on the comparison, and
e) displaying the selected item of secondary content in a browser window concurrently with the primary content.

2. A method according to claim 1, wherein the client-side software application responds to an operating event of the user's computer by transmitting a request for secondary content.

3. A method of delivering secondary content for display concurrently with primary content by a web browser running on a user's computer, comprising:
a) running a client-side software application on the user's computer, wherein the client-side software application collects usage data and generates a user profile based on usage data, and, in response to an operating event of the user's computer by transmitting a request for secondary content and at least part of the user profile,
b) receiving at least one item of secondary content at the user's computer after transmission of the request, and
c) displaying a selected item of secondary content in a browser window concurrently with the primary content, wherein the selected item of secondary content has a characteristic that matches a part of the user profile.
